(19) United States
(12) Patent Application Publication
(10) Pub. No.: US 2005/0007556 A1
(43) Pub. Date: Jan. 13, 2005

(54) Optical device and projector

(75) Inventor: Yoshiyuki Yanagisawa, Matsumoto-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/766,931

(22) Filed: Jan. 30, 2004

(30) Foreign Application Priority Data
Feb. 4, 2003 (JP) 2003/027068

(51) Int. Cl. G03B 21/00

(52) U.S. Cl. 353/31

(57) ABSTRACT

An optical device 44 comprises incident side transparent members 447A which are interposed between the respective members of light flux incident end surfaces of a cross dichroic prism 444 and three light modulating devices 440 to hold and fix the respective light modulating devices 440. Further, the incident side transparent members 447A are made of a thermal conductive material and at least two incident side transparent members 447A of the three incident side transparent members 447A are different in thermal resistance. As a result, there are provided an optical device which is capable of performing an efficient cooling without damaging silence of a projector and equalizing unevenness in heating quantity in a plurality of optical elements such as light modulating devices, and a projector.

### BACKGROUND OF THE INVENTION

1. Field of Invention

The present invention relates to an optical device including a plurality of light modulating devices to modulate a plurality of color light components in accordance with image information for every color light, and a color synthesizing optical device having a plurality of light flux incident end surfaces arranged to oppose the respective light modulating devices to synthesize and emit the color light components modulated by the respective light modulating devices, and a projector.

2. Description of Related Art

Related art devices include a so-called three-plate projector in which a light flux emitted from a light source is separated into red, green, and blue light components of three primary colors by a dichroic mirror. Related art further includes respective color light components being modulated by three liquid crystal panels in accordance with image information for every color light, the modulated color light components being synthesized by a cross dichroic prism, and a color image being enlarged and projected through a projection lens.

In such a related art projector, the respective liquid crystal panels must be positioned at the back focus positions of the projection lens. For this reason, in related art devices, an optical device in which the liquid crystal panels are directly fixed to and integrated into the light flux incident end surfaces of the cross dichroic prism while locating at the light flux incident end surfaces, has been adopted.

In the integrated optical device, in order to mount the liquid crystal panels on the cross dichroic prism, as disclosed in related art document Japanese Unexamined Patent Application Publication No. 2000-221588 (see paragraph [0041] and FIG. 5), the related art discloses a method of attaching and fixing the liquid crystal panels to the light flux incident end surfaces of the cross dichroic prism. The related art discloses forming holes in four corners of each of panel holding frames housing the respective liquid crystal panels and inserting pins into the holes.

Further, related art document Japanese Unexamined Patent Application Publication No. 10-10994 (see paragraph [0052] and FIG. 6), discloses a method of attaching and fixing the liquid crystal panels to the light flux incident end surfaces of the cross dichroic prism by interposing wedge-shaped spacers between the panel holding frames of the liquid crystal panels and the cross dichroic prism.

Since the optical elements such as the liquid crystal panels, polarizing plates, or the like constituting such an optical device are heated by the light flux emitted from a light source, related art documents disclose a cooling system utilizing a fan is incorporated in a projector, and during using the projector, the optical elements such as the liquid crystal panels, the polarizing plates, or the like are cooled by the fan.

### SUMMARY OF THE INVENTION

However, recently, since the optical devices are smaller in size along with a decrease in size of the projector, gaps between the light flux incident end surfaces of the cross dichroic prism and the liquid crystal panels are reduced, such that it is difficult to allow cooled air to flow through the gaps for the efficient cooling. Particularly, in accomplishing an increase in brightness of the projector, attention should be paid for how to efficiently cool the liquid crystal panels.

Here, one possible solution is to increase a blowing air quantity of the cooling fan. However, since noise is increased due to the driving of the cooling fan, a problem of silence still remains.

Further, in such an optical device of the related art, since heating quantities of the respective liquid crystal panels are dependent upon a relative radiation intensity in a light-emission spectrum, unevenness in heating quantity may be caused in the respective liquid crystal panels. Further, a temperature difference is caused in the liquid crystal panels due to unevenness in heating quantity, such that the respective panel holding frames have different thermal expansion quantity. Accordingly, the pixel positions of the liquid crystal panels may be varied, such that a deterioration in image quality such as pixel variation may be caused.

Here, it can be considered that the blowing air quantity from the cooling fan is made to correspond to the difference in heating quantity of the liquid crystal panels. However, studies on shapes of ducts for guiding the cooled air from the cooling fan to a predetermined position have shown that, a plurality of cooling fans having different blowing air quantities are required, which makes it more difficult to decrease in size of projectors.

Exemplary embodiments of the present invention include an optical device which is capable of efficiently cooling the projector without damaging silence and equalizing temperatures of the respective liquid crystal panels due to unevenness in heating quantity in a plurality of optical elements such as the light modulating devices, and a projector.

According to an exemplary aspect of the present invention, there is provided an optical device having a plurality of light modulating devices to modulate a plurality of color light components in accordance with image information for every color light component, and a color synthesizing optical device having a plurality of light flux incident end surfaces arranged to oppose the respective light modulating devices to synthesize and to emit the color light components modulated by the respective light modulating devices. According to an exemplary aspect, the optical device includes a plurality of incident side transparent members made of a thermal conductive material which are interposed between the respective members of the light flux incident end surfaces and the light modulating devices, and connected to the light modulating devices, at least two incident side transparent members of the plurality of incident side transparent members having different thermal resistances.

Here, the incident side transparent members may be made of various kinds of materials, for example, a thermal conductive material such as sapphire, crystal, quartz, fluorite.

According to exemplary embodiments of the present invention, since the optical device includes the incident side transparent members, and the incident side transparent members are interposed between the respective members of the light flux incident end surfaces of the color synthesizing optical device and the plurality of light modulating devices and connected to the plurality of light modulating devices, the heat generated in the respective light modulating devices can be radiated via the incident side transparent members made of thermal conductive material. Therefore, the respective light modulating devices are efficiently cool with a simple configuration, without increasing a blowing air quantity of a cooling fan.

Further, since at least two incident side transparent members of the plurality of incident side transparent members have different thermal resistances, it can be configured in consideration of a difference in heating quantity of the light modulating devices. Accordingly, the thermal resistance of the incident side transparent member disposed at a space between the respective members of the light modulating device having a relatively large heating quantity and the light flux incident end surface of the color synthesizing optical device, becomes smaller than the thermal resistance of the incident side transparent members interposed between other members of the light modulating devices and the light flux incident end surfaces of the color synthesizing optical device. In such a configuration, the heat of the light modulating device having a relatively large heating quantity can be efficiently cooled via the incident side transparent member having a relatively small heating quantity, such that unevenness in temperature of the light modulating devices is equalized with a simple configuration. Therefore, good quality of optical image formed in the optical device is maintained.

According to another exemplary aspect of the present invention, an optical device has a plurality of light modulating devices to modulate a plurality of color light components in accordance with image information for every color light component. A color synthesizing optical device has a plurality of light flux incident end surfaces opposing the respective light modulating devices to synthesize and to emit the color light components modulated by the respective light modulating devices. The optical device includes a plurality of incident side transparent members made of a thermal conductive material which are interposed between the respective members of the light flux incident end surfaces and the light modulating devices excluding at least one space, and are connected to the light modulating devices.

Here, the incident side transparent members may be made of for example, a thermal conductive material such as sapphire, crystal, quartz, fluorite, like the incident side transparent members in the above-mentioned optical device.

According to exemplary embodiments of the present invention, since the optical device includes the incident side transparent members, and the incident side transparent members are interposed between the respective members of the light flux incident end surfaces of the color synthesizing optical device and the plurality of light modulating devices excluding at least one space and connected to the light modulating devices, the heat generated in the light modulating devices disposed at positions in accordance with the incident side transparent members can be radiated via the incident side transparent members made of thermal conductive material. Therefore, without increasing the blowing air quantity of the cooling fan, the light modulating devices can be efficiently cooled with a simple configuration in accordance with differences in heating quantity of the respective light modulating devices.

Further, in consideration of the difference in heating quantity of the respective light modulating devices, the incident side transparent member is omitted at a space between the members of the light modulating device having a relatively small heating quantity and the light flux incident end surface of the color synthesizing optical device, while the incident side transparent members are provided at spaces between other members of the light modulating devices and the light flux incident end surfaces of the color synthesizing optical device. In such a configuration, the heat generated in the light modulating device having a relatively large heating quantity can be radiated via the incident side transparent member, such that unevenness in temperature of the light modulating devices is equalized with a simple configuration. Therefore, good quality of optical image formed in the optical device can be maintained.

In the optical device of exemplary embodiments of the present invention, at least two incident side transparent members of the plurality of incident side transparent members may be made of thermal conductive materials having different thermal conductivities.

According to exemplary embodiments of the present invention, since at least two incident side transparent members of the plurality of incident side transparent members interposed between the respective members of the light flux incident end surfaces of the color synthesizing optical device and the plurality of light modulating devices are made of thermal conductive materials having different thermal conductivities, the thermal resistances in the spaces between the respective members at which the incident side transparent members are disposed can be maintained.

That is, as the above-mentioned optical device, when the incident side transparent members are disposed at the spaces between all of the respective members of the light flux incident end surfaces of the color synthesizing optical device and the plurality of light modulating devices, unevenness in temperature of the respective light modulating devices can be easily equalized by making at least two incident side transparent members of thermal conductive materials having different thermal conductivities, in consideration of the difference in heating quantity of the respective light modulating devices.

Further, as the above-mentioned optical device, when the incident side transparent members are disposed at the spaces between the respective members of the light flux incident end surfaces of the color synthesizing optical device and the plurality of light modulating devices excluding at least one space, the thermal resistances can be made different in the space between the members at which the incident side transparent member is not disposed and the spaces between the members at which the incident side transparent members are disposed. Further in consideration of a difference in heating quantity of the respective light modulating devices, thermal resistances can be made different even in the spaces between the respective members at which the incident side transparent members are disposed, by making at least two incident side transparent members of the incident side transparent members to be interposed of thermal conductive materials having different thermal conductivities. Therefore, unevenness in temperature of the respective light modulating devices can be easily equalized.

In the optical device of exemplary embodiments of the present invention, at least two incident side transparent members of the plurality of incident side transparent members may have different sectional areas in a direction along an end surface crossing the plurality of light flux incident end surfaces of the color synthesizing optical device.

In general, the thermal resistance of the member has a correlation with the thermal conductivity of the member and also has a correlation with the sectional area of the member.

According to exemplary embodiments of the present invention, since at least two incident side transparent members of the plurality of incident side transparent members disposed at the spaces between the respective member of the light flux incident end surfaces of the color synthesizing optical device and the plurality of light modulating devices have different sectional areas in the direction along an end surface crossing the plurality of light flux incident end surfaces of the color synthesizing optical device, the thermal resistances in the spaces between the respective members at which the incident side transparent members are disposed can be made different from each other.

That is, as the above-mentioned optical device, when the incident side transparent members are disposed at the spaces between all of the respective members of the light flux incident end surfaces of the color synthesizing optical device and the plurality of light modulating devices, in consideration of a difference in heating quantity of the light modulating devices, unevenness in temperature of the light modulating devices can be easily equalized with a simple configuration, by forming the sectional areas of at least two incident side transparent members different from each other.

Further, as the above-mentioned optical device, when the incident side transparent members are disposed at the spaces between the respective members of the light flux incident end surfaces of the color synthesizing optical device and the plurality of light modulating devices excluding at least one space, the thermal resistances can be made different in the space between the respective members at which the incident side transparent member is not disposed and the spaces between the respective members at which the incident side transparent members are disposed. Further in consideration of a difference in heating quantity of the respective light modulating devices, to thermal resistances can be made different even in the spaces between the respective members at which the incident side transparent members are disposed, by making different sectional areas of at least two incident side transparent members of the incident side transparent members to be interposed. Therefore, unevenness in temperature of the respective light modulating devices with a simple configuration can be equalized.

The optical device of exemplary embodiment of the present invention may further comprise a pedestal made of a thermal conductive material which is provided in at least one end surface of respective end surfaces crossing the light flux incident end surfaces of the color synthesizing optical device, and the incident side transparent members may be connected to the side surfaces of the pedestal.

Here, the pedestal may be made of various materials, for example, the same material as the above-mentioned incident side transparent members or metallic material such as aluminum, magnesium, titanium, or alloy including the metallic material as a major material.

According to exemplary embodiments of the present invention, since the optical device comprises the pedestal made of thermal conductive material and the incident side transparent members are connected to the side surfaces of the pedestal, the heat generated in the light modulating devices can be radiated through the incident side transparent members and can be further radiated through the pedestal, such that cooling efficiency of the light modulating devices can be enhanced even more.

It is preferable that the optical device of exemplary embodiments of the present invention further include an emitting side transparent member made of thermal conductive material, which opposes a light flux emitting end surface of the color synthesizing optical device.

Here, the emitting side transparent member may be made of various kinds of material, for example, thermal conductive material such as sapphire, crystal, quartz, fluorite, like the incident side transparent members.

According to exemplary embodiments of the present invention, since the optical device comprises the emitting side transparent member, the emitting side transparent member as well as the incident side transparent members can function as a radiation path of the heat generated in the light modulating devices, for example, by connecting the emitting side transparent member and the incident side transparent members, such that the cooling efficiency of the light modulating devices can be enhanced even more.

In the optical device of exemplary embodiments of the present invention, the emitting side transparent member may have a thermal resistance smaller than those of the incident side transparent members.

According to exemplary embodiments of the present invention, since the emitting side transparent member has a thermal resistance smaller than those of the incident side transparent members, the heat transfer from the incident side transparent members to the emitting side transparent member can be carried out better, for example, by connecting the emitting side transparent member and the incident side transparent members, such that unevenness in temperature of the light modulating devices can be rapidly equalized.

In the optical device of exemplary embodiments of the present invention, the emitting side transparent member is preferably made of a thermal conductive material having a thermal conductivity higher than those of the incident side transparent members.

According to exemplary embodiments of the present invention, since the emitting side transparent member is made of a thermal conductive material having a thermal conductivity higher than those of the incident side transparent members, the emitting side transparent member can have a thermal resistance smaller than that of the incident side transparent members, by making the emitting side transparent member of a material different from those of the incident side transparent members.

In the optical device of exemplary embodiments of the present invention, a sectional area of the emitting side transparent member in a direction along an end surface crossing the plurality of light flux incident end surfaces of the color synthesizing optical device may be larger than those of the incident side transparent members.

According to exemplary embodiments of the present invention, since the sectional area of the emitting side transparent member in a direction along an end surface crossing the plurality of light flux incident end surfaces of the color synthesizing optical device is larger than those of the incident side transparent members, the emitting side transparent member can have a thermal resistance smaller than those of the incident side transparent members with a simple configuration, by forming the emitting side transparent member and the incident side transparent members in different shapes.

According to a further exemplary aspect of the present invention, there is also provided a projector to modulate a light flux emitted from a light source in accordance with image information to form an optical image, and enlarging and projecting the optical image, the projector including the above-mentioned optical device.

According to exemplary embodiments of the present invention, since the projector includes the above-mentioned optical device, the same operational advantages as the above-mentioned optical device can be accomplished.

Further, the projector may include the above-mentioned optical device, and thus it is possible to manufacture the projector which is capable of coping with a miniaturization and providing high quality image, with high silence and high cooling efficiency.

In the projector of exemplary embodiments of the present invention, preferably, the optical device includes an emitting side transparent member made of a thermal conductive material arranged to oppose a light flux emitting end surface of the color synthesizing optical device, and in an optical component case body for housing the optical device, ventilating openings for passing cooled air are formed at positions corresponding to the respective light flux incident end surfaces and the light flux emitting end surface of the color synthesizing optical device.

According to exemplary embodiments of the present invention, since the ventilating openings are formed in the optical component case body for housing the optical components, the cooling of the heat generated in the light modulating devices can be carried out by compulsory cooling by a cooling fan and conductive radiation, by blowing the cooled air into the incident side transparent members and the emitting side transparent member through the ventilating openings using a cooling fan together, such that the cooling efficiency of the light modulating devices can be enhanced even more.

### BRIEF DESCRIPTION OF THE DRAWINGS

FIG. 1 is a schematic perspective view showing a projector according to the present exemplary embodiment as seen from the top;

FIG. 2 is a schematic that shows an inside configuration of the projector in the respective exemplary embodiments;

FIG. 3 is a schematic perspective view showing an optical unit in the respective exemplary embodiments as seen from the top;

FIG. 4 is a schematic plan view showing an optical system of the projector in the respective exemplary embodiments;

FIG. 5 is a schematic perspective view showing a structure of a lower light guide in the respective exemplary embodiments;

FIG. 6 is a schematic exploded perspective view showing a state in which a light source is removed from the optical unit in the respective exemplary embodiments;

FIG. 7 is a schematic perspective view showing the light guide in the respective exemplary embodiments as seen from the bottom;

FIG. 8 is a schematic perspective view showing the optical device according to the first exemplary embodiment as seen from the top;

FIG. 9 is a schematic exploded perspective view showing the optical device according to the exemplary embodiment;

FIG. 10 is a schematic that shows a mounting structure of the optical device on the light guide in the exemplary embodiment;

FIG. 11 is a schematic that shows a cooling flow path of a panel cooling system A in the exemplary embodiment;

FIG. 12 is a schematic cross-sectional view showing a cooling structure of the optical device by the panel cooling system A in the exemplary embodiment;

FIG. 13 is a schematic that shows a cooling flow path of a light source cooling system B in the exemplary embodiment;

FIG. 14 is a schematic perspective view showing an optical device in a second exemplary embodiment as seen from the top; and

FIG. 15 is a schematic perspective view showing an optical device in a third exemplary embodiment as seen from the top.

### DETAILED DESCRIPTION OF PREFERRED EMBODIMENTS

1. First Exemplary Embodiment

A first exemplary embodiment of the present invention will be described with reference to the drawings.

1-1. Primary Configuration of Projector

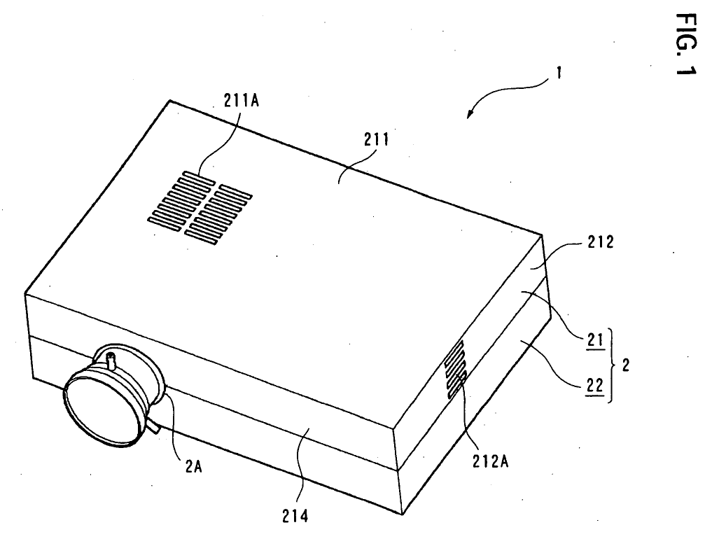

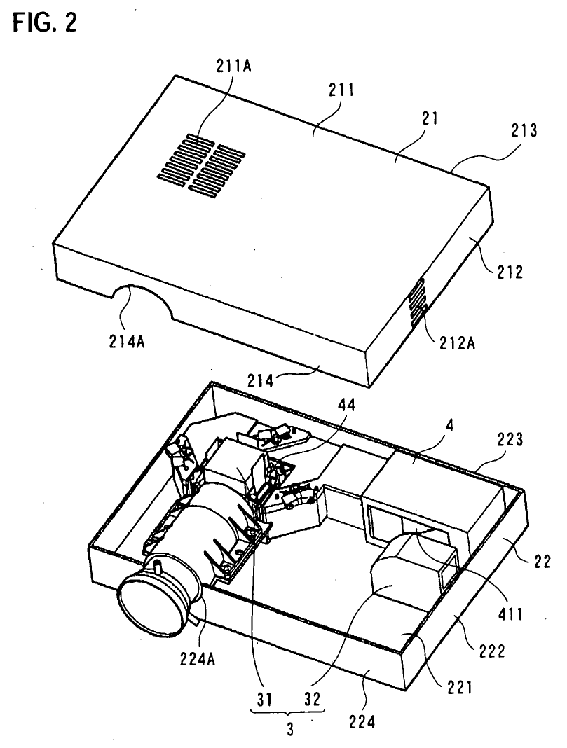

FIG. 1 is a schematic perspective view showing a projector 1 according to a first exemplary embodiment of the present invention as seen from the top. FIG. 2 is a schematic perspective view showing a state in which an upper case 21 is removed in FIG. 1.

The projector 1 includes an outer case 2 having a substantially rectangular shape, a cooling unit 3 for cooling heat staying within the projector 1, and an optical unit 4 to optically process a light flux emitted from a light source to form an optical image in accordance with image information.

In FIG. 2, although not shown, a power source block, a lamp driving circuit and so on are housed in spaces other than the optical unit 4 within the outer case 2.

The outer case 2 includes of an upper case 21 forming the top surface, the front surface, the rear surface, and the side surfaces of the projector 1 and a lower case 22 forming the bottom surface, the front surface, the side surfaces, and the rear surface of the projector 1, which are made of metallic material. The cases 21 and 22 are coupled to each other with screws or the like. Moreover, the outer case 2 may be made of a synthetic resin or the like, not limited to the metallic material.

The upper case 21 includes of a top surface portion 211, and side surface portions 212 along the periphery of the top surface portion 211, a rear surface portion 213, and a front surface portion 214.

In the top surface portion 211, air inlet 211A which is positioned above an optical device 44 described below in the optical unit 4 and through which external cooled air is introduced by the cooling unit 3, are provided.

In one side surface portion 212 (the right side surface as seen from the front surface) of the side surface portions 212, air outlet 212A through which the heated air in the projector 1 is discharged by the cooling unit 3, are provided.

In the rear surface portion 213, although not shown, various terminals to connect to various instruments such, as a connection terminal to a computer, a video input terminal, a connection terminal to an audio instrument and so on are provided, and an interface substrate on which a signal processing circuit to process image signals or the like, is mounted is disposed inside the rear surface portion 213.

A notched portion 214A (see FIG. 2) is formed in the front surface portion 214 and forms a circular opening 2A in combination with the lower case 22. A part of the optical unit 4 disposed inside the outer case 2 is exposed outside through the opening 2A. An optical image formed by the optical unit 4 is emitted through the opening 2A, such that an image is displayed on a screen.

The lower case 22, as shown in FIG. 2, is comprised of a bottom surface portion 221, and side surface portions 222 along the periphery of the bottom surface portion 221, a rear surface portion 223, and a front surface portion 224.

In the bottom surface portion 221, although not shown, an opening which is positioned below the optical unit 4 and through which a light source device 411 described below is attached and detached is formed, and a lamp cover is detachably provided in the opening in an engagement manner.

A notched portion 224A is formed in the front surface portion 224 and constitutes the circular opening 2A together with the notched portion 214A in combination with the upper case 21.

The cooling unit 3 sends cooled air through a cooling flow path formed inside the projector 1, thereby cooling heat generated inside the projector 1. As shown in FIG. 2, the cooling unit 3 includes an axial flow fan 31, which is positioned above the optical device 44 described below in the optical unit 4, to suck up the cooled air from the air inlet 211A formed in the top surface portion 211 of the upper case 21. A sirocco fan 32, which is positioned in the vicinity of the light source device 411 described below in the optical device 44, introduces the air inside the optical unit 4 and the projector 1 and discharges the heated air through the air outlet 212A formed in one side surface portion 212 of the upper case 21.

The optical unit 4 is a unit for optically processing the light flux emitted from a light source lamp 416 to form an optical image in accordance with image information. The optical unit 4, as shown in FIG. 2, has substantially an L shape extending along the rear surface portion 223 from the right side surface portion 222 of the lower case 22 and also along the left side surface portion 222 to the front surface portion 214 in a plan view. Although not shown, the optical unit 4 is electrically connected to a power source for being supplied with power through a power cable and supplying the power to the light source lamp 416 of the optical unit 4. Further, although not shown, a control substrate to receive image information and to perform control and operation processes on image information to project the optical image in accordance with image information, and to control liquid crystal panels 441 constituting light modulating devices 440 described below, is disposed above the optical unit 4.

1-2. Detailed Configuration of Optical System

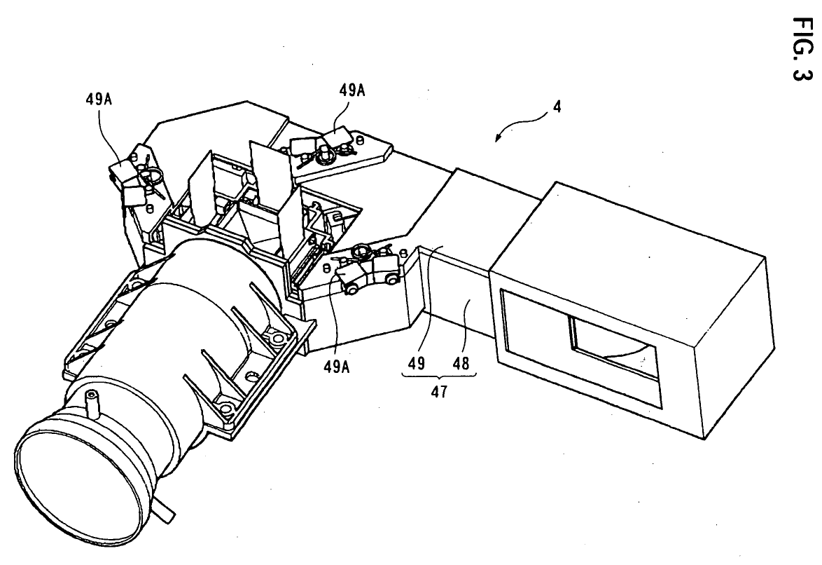

FIG. 3 is a schematic perspective view showing the optical unit 4 as seen from the top.

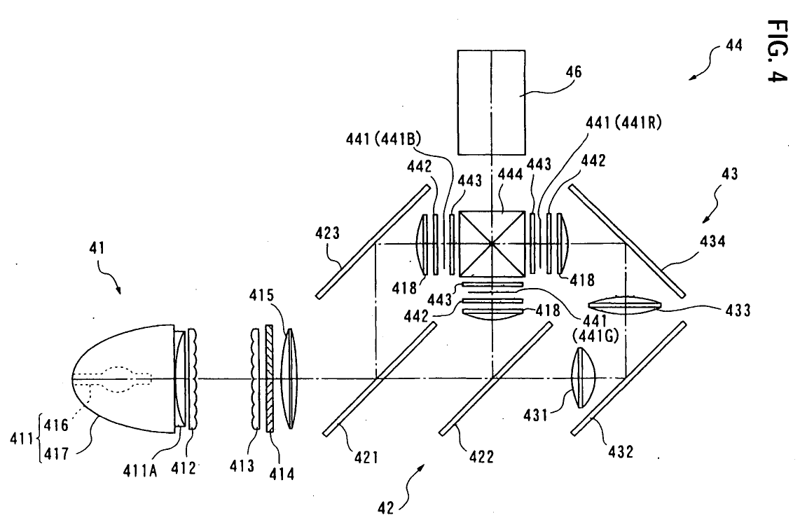

FIG. 4 is a schematic plan view showing an optical system in the optical unit 4.

As shown in FIG. 3 or 4, the optical unit 4 includes of an integrator illumination optical system 41, a color separating optical system 42, a relay optical system 43, an optical device 44, a projection lens 46, and a light guide 47 in which the optical components 41 through 44 and 46 are housed and arranged.

The integrator illumination optical system 41 is an optical system for almost uniformly illuminating image forming areas of three liquid crystal panels 441 (liquid crystal panels 441R, 441G and 441B are denoted for red, green, and blue light components, respectively) constituting the optical device 44. As shown in FIG. 4, the integrator illumination optical system 41 includes of a light source device 411, a first lens array 412, a second lens array 413, a polarization converting element 414, and a superimposing lens 415.

The light source device 411 includes a light source lamp 416 to emit light in a radial shape, an elliptical mirror 417 to reflect the radial light emitted from the light source lamp 416, and a collimating concave lens 411A to collimate the light emitted from the light source lamp 416 and reflected from the elliptical mirror 417. The plane portion of the collimating concave lens 411A is provided with an UV filter not shown. As the light source lamp 416, a halogen lamp, a xenon lamp, a metallic halide lamp, and a high-pressure mercury lamp are mainly used. Further, in place of the elliptical mirror 417 and the collimating concave lens 411A, a parabolic mirror may be used.

The first lens array 412 has a configuration in which small lenses having an almost rectangular shape as seen in an optical axis direction, are arranged in a matrix shape. The small lenses divide the light flux emitted from the light source lamp 416 into a plurality of partial light fluxes.

The second lens array 413 has a configuration substantially similar to that of the first lens array 412, that is, a configuration in which small lenses are arranged in a matrix shape. The second lens array 412 serves as forming images of the small lenses of the first lens array 412 on the liquid crystal panels 441 along with the superimposing lens 415.

The polarization converting element 414 is interposed between the second lens array 413 and the superimposing lens 415 and is unified with the second lens array 413. The polarization converting element 414 converts the light from the second lens array 413 into one kind of polarized light, thereby enhancing the utilization rate of light in the optical device 44.

Specifically, the respective partial light components converted into one kind of polarized light by the polarization converting element 414 finally are substantially superposed on the liquid crystal panels 441R, 441G and 441B of the optical device 44 through the superimposing lens 415. Since only one kind of polarized light can be used in a projector employing liquid crystal panels to modulate the polarized light, almost a half of the light from the light source lamp 416 emitting randomly-polarized light cannot be utilized.

The first lens array 412, the second lens array 413, and the polarization converting element 414 are integrally combined and fixed into the light guide 47.

The color separating optical system 42 includes two dichroic mirrors 421 and 422 and a reflecting mirror 423, and has a function of separating the plurality of partial light fluxes emitted from the integrator illumination optical system 41 into three color light components of red, green, and blue by utilizing the dichroic mirrors 421 and 422.

The relay optical system 43 includes an incident lens 431, a relay lens 433, and reflecting mirrors 432 and 434, and has a function of guiding the color light separated by the color separating optical system 42, that is, the red light, to the liquid crystal panel 441R.

At this time, the dichroic mirror 421 of the color separating optical system 42 reflects the blue light of the light flux emitted from the integrator illumination optical system 41 and transmits the red light and the green light. The blue light reflected from the dichroic mirror 421 is also reflected from the reflecting mirror 423 and reaches the blue liquid crystal panel 441B through a field lens 418. The field lens 418 converts the respective partial light fluxes emitted from the second lens array 413 into light fluxes parallel to the central axis (main light beam). The field lenses 418 provided at light entry sides of the other liquid crystal panel 441G and 441R have the same function.

The green light component among the red and green light components passing through the dichroic mirror 421, is reflected from the dichroic mirror 422 and reaches the green liquid crystal panel 441G through the field lens 418. In the meantime, the red light passes through the dichroic mirror 422 and the relay optical system 43 and reaches the red liquid crystal panel 441R through the field lens 418. Since the optical path of the red light is longer than those of the other color light components, the relay optical system 43 is used for the red light, such that the utilization rate of light is reduced or prevented from being deteriorated due to diffusion of light, etc. That is, the light entering the incident lens 431 is delivered to the field lens 418 as it is.

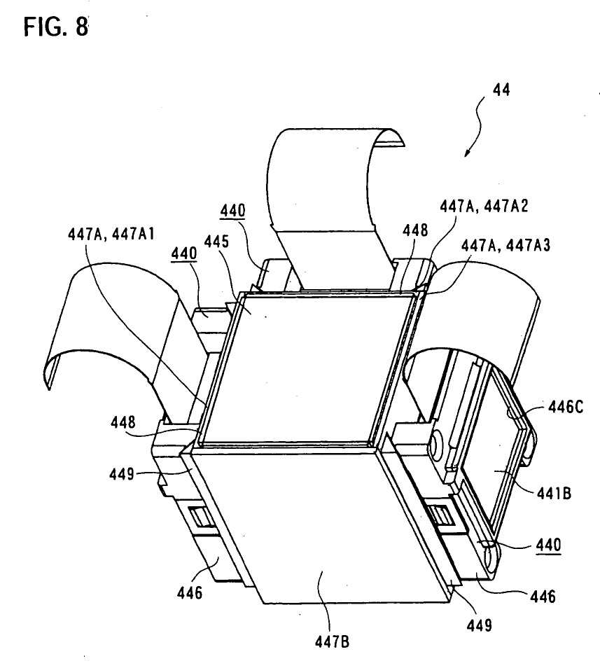

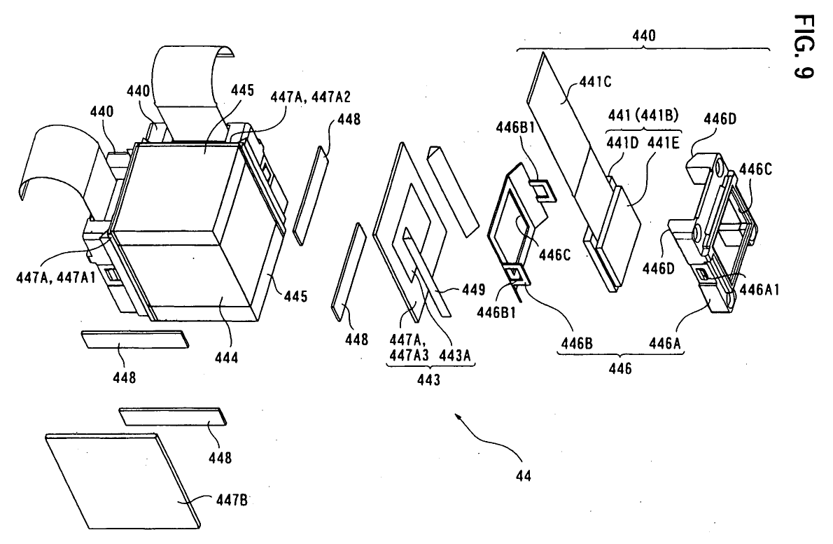

The optical device 44 is obtained by integrally forming three liquid crystal panels 441 (441R, 441G and 441B) constituting light modulating devices 440 (see FIGS. 8 and 9) and a cross dichroic prism 444 as an color synthesizing optical device.

The liquid crystal panels 441 employ, for example, poly silicon TFTs as switching elements. The color light components separated by the color separating optical system 42 are modulated in accordance with image information by the three liquid crystal panels 441R, 441G and 441B, incident side polarizing plates 442, and emitting side polarizing plates 443, thereby forming an optical image.

Although details will be described below, each liquid crystal panel 441 comprises a driving substrate in which the switching elements of TFT are arranged in a matrix shape and pixel electrodes supplied with a voltage through the switching elements are provided, and a counter substrate comprising a counter electrode opposing the pixel electrodes.

The cross dichroic prism 444 synthesizes the respective modulated color images emitted from the three liquid crystal panels 441R, 441G and 441B to form a color image. In the cross dichroic prism 444, a dielectric multilayer film to reflect the red light and a dielectric multilayer film to reflect the blue light are formed in an almost X shape along the boundary surfaces of four rectangular prisms, such that the three color light components are synthesized by the dielectric multilayer films.

The projection lens 46 is formed as a combined lens obtained by combining a plurality of lenses. The projection lens 46 enlarges and projects the color image synthesized by the cross dichroic prism 444 on a screen. The projection lens 46 comprises a lever 46A to adjust the focus and the magnification of the color image projected on the screen.

The light guide 47 includes a lower light guide 48 constituting the bottom surface, the front surface, and the side surfaces, and a lid-shaped upper light guide 49 to close the upper opening of the lower light guide 48.

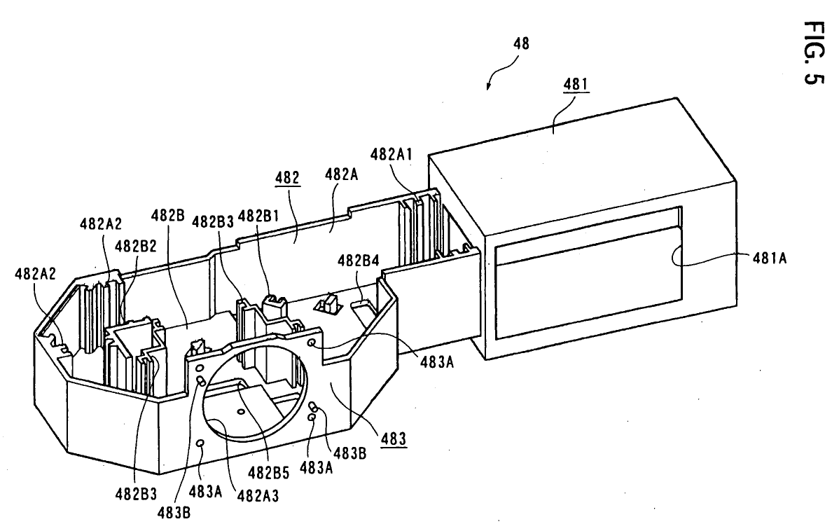

FIG. 5 is a schematic perspective view showing the lower light guide 48.

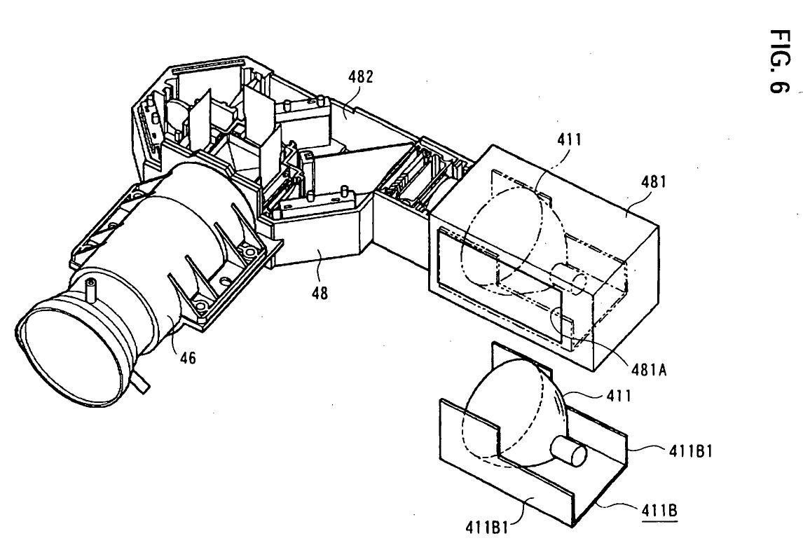

FIG. 6 is a schematic perspective view showing a state in which the light source device 411 is removed from the light guide 47.

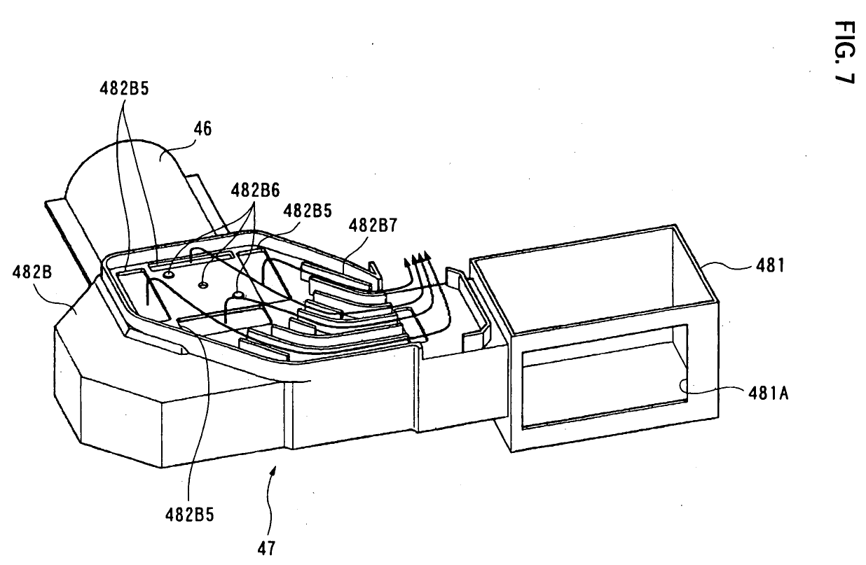

FIG. 7 is a schematic perspective view showing the light guide 47 as seen from the bottom.

As shown in FIG. 6, the lower light guide 48 includes a light source housing section 481 to house the light source device 411, an optical component housing section 482 to house the optical components 411A, 412 through 415, and 42 through 44, and a projection lens fixing section 483 to fix the projection lens 46.

As shown in FIGS. 5 to 7, the light source housing section 481 has a box shape of which the lower side is opened and which has a rectangular opening 481A in the inner side surface. The light source device 411 is housed in the light source housing section 481.

Here, as shown in FIG. 6, the light source device 411 is mounted on and fixed to a fixing plate 411B and is housed in the light source housing section 481 from the bottom side of the light source housing section 481 along with the fixing plate 411B.

The fixing plate 411B has erected pieces 411B1 extending from both side edges of a plate-shaped member and the erected pieces 411B1 have different heights in accordance with the light flux emitted from the light source device 411. The height over from the center of the elliptical mirror 417 to the front side of the light source device 411 is almost equal to the height of the light source device 411. The rear side of the elliptical mirror 417 is smaller than the height of the light source device 411.

In the state where the light source device 411 is housed in the light source housing section 481 of the lower light guide 48 along with the fixing plate 411B, the front side of the light source device 411 is closed with the opening 481A formed in the light source housing section 481 and the erected pieces 411B1 and the rear side of the light source device 411 is opened to pass air.

Since the front side of the light source device 411 is closed, it is possible to reduce or prevent the light flux emitted from the light source device 411 from leaking externally, and since the rear side thereof is opened to pass air, heat generated in the light source device 411 does not stay in the light source housing section 481.

As shown in FIG. 5, the optical component housing section 482 includes the side portion 482A and the bottom portion 482B.

A first groove portion 482A1 to insert the unit including the collimating concave lens 411A, the first lens array 412, the second lens array 413, and the polarization converting element 414 and the superimposing lens 415 from the top side thereof in a sliding manner, and a second groove portion 482A2 to insert the incident lens 431, the reflecting mirror 432, and the relay lens 433 from the top side thereof in a sliding manner, are formed in the inner side surface of the side portion 482A.

A circular opening 482A3 is formed in the front side of the side portion 482A correspondingly to the light flux emitting end position from the optical device 44, and the image light enlarged and projected by the projection lens 46 is displayed on the screen through the opening 482A3.

In the bottom portion 482B, a first boss portion 482B1 to support the dichroic mirror 421, a second boss portion 482B having grooves corresponding to the second groove portion 482A2, and a third boss portion 482B3 surrounding the optical device 44, are raised from the bottom surface.

Further, in the bottom portion 482B, Air inlet 482B4 to cool the unit including the polarization converting element 414, air outlet 482B5 (see FIG. 7) as the ventilating opening formed correspondingly to the positions of the liquid crystal panels 441 and the light flux emitting end surface of the cross dichroic prism 444 of the optical device 44, and holes 482B6 (see FIG. 7) to install the optical device 44 at the center surrounded with the air outlet 482B5, are formed.

Furthermore, as shown in FIG. 7, the outer surface of the bottom portion 482B is provided with ducts 482B7 to outwardly guide the air discharged from the air outlet 482B5 in a state where the lower light guide 48 and the bottom surface portion 221 of the lower case 22, are in contact with each other.

The projection lens fixing section 483 is positioned at the front side of the side portion 482A of the optical component housing section 482, is formed in a rectangular shape, and is provided integrally to the side portion 482A.

Holes 483A to fix the projection lens 46 are formed in four corners of the projection lens fixing section 483 and protrusions 483B used to locate the projection lens 46 are diagonally formed in the vicinity of the two holes 483A.

Since the projection lens fixing section 483 is provided integrally to the optical component housing section 482, the weight of the projection lens 46 is supported.

As shown in FIG. 3, the upper light guide 49 closes the top opening of the lower light guide 48 other than the top side of the optical device 44, and supports the optical components, the reflecting mirror 423, the dichroic mirror 422, and the reflecting mirror 434 not supported by the first groove portion 482A1 and the second groove portion 482A2 of the lower light guide 48.

A portion of the upper light guide 49 corresponding to the optical component position includes an adjusting section 49A, such that the posture adjustment of the optical components and the adjustment of lighting axes of the respective color light components can be carried out of the adjusting section 49A

1-3. Structure of Optical Device

FIG. 8 is a perspective view showing the optical device 44 according to the first exemplary embodiment as seen from the top.

FIG. 9 is a schematic perspective view showing the optical device 44 according to the first exemplary embodiment.

In FIG. 9, the decomposition of the optical device 44 is executed at the liquid crystal panel 441B side and the light flux emitting side of the cross dichroic prism 444. The liquid crystal panels 441R and 441G are similar to the liquid crystal panel 441B.

The optical device 44 modulates the light flux emitted from the light source lamp 416 in accordance with image information, synthesizes the modulated color light components, and projects the synthesized light as the optical image. As shown in FIGS. 8 and 9, the optical device 44 includes light modulating devices 440 to perform the optical modulation, a cross dichroic prism 444 to synthesize the color light components emitted from the light modulating devices 440, pedestals 445 fixed to the top and bottom surfaces (a pair of end surfaces substantially perpendicular to the light flux incident end surface) of the cross dichroic prism 444, respectively, incident side transparent members 447A attached to the side surfaces of the pedestals 445 and opposing the respective light flux incident end surfaces of the cross dichroic prism 444, an emitting side transparent member 447B opposing the light flux emitting end surface, elastic members 448 interposed between the incident side transparent members 447A and the side surfaces of the pedestals 445, and wedge-shaped spacers 449 interposed between the light modulating devices 440 and the incident side transparent members 447A.

The light modulating devices 440 are comprised of the liquid crystal panels 441R, 441G and 4411B to modulate the light flux emitted from the light source lamp 416 in accordance with image information and holding frames 446 to house and holding the respective liquid crystal panels 441R, 441G and 441B. As shown in FIG. 9, in the liquid crystal panel 441B, liquid crystal is injected and sealed between a glass substrate as the driving substrate (for example, TFT substrate) 441D and a glass substrate as the counter substrate 441E, and a control cable 441C extends from between the glass substrates.

A light-transmitting dustproof plate to allow dust attached to the panel surface to be invisible by making the panel surface position of the liquid crystal panel 441 depart from the back focus position of the projection lens 46, is generally fixed to the driving substrate 441D and/or the counter substrate 441E. Here, as the light-transmitting dustproof plate, a plate member having excellent thermal conductivity, such as sapphire or quartz is fixed.

The holding frame 446 holds and fixes the liquid crystal panel 441B. As shown in FIG. 9, the holding frame 446 includes a housing body 446A to house the liquid crystal panel 441B and a supporting plate to press and to fix the housed liquid crystal panel 441B by engaging with the housing body 446A.

The holding frame 446 grasps the outer circumference of the light-transmitting dustproof plate fixed to the counter substrate 441E of the liquid crystal panel 441B and thus houses the liquid crystal panel 441B in the housing body 446A. An opening 446C is provided at the position of the holding frame corresponding to the panel surface of the housed liquid crystal panel 441B.

Further, as shown in FIG. 9, the fixing of the housing body 446A and the supporting plate 446B is performed by engagement of hooks 446B1 provided at both sides of the supporting plate 446B with hook locking portions 446A1 provided at the corresponding positions of the housing body 446A.

Here, the liquid crystal panel 441B is exposed to the opening 446C of the holding frame 446, and the exposed portion forms an image forming area. That is, the color light B is introduced into the exposed portion of the liquid crystal panel 441B, where the optical image is formed in accordance with image information.

Sloping surfaces 446D are formed in the left and right edges of the light flux emitting end surface of the housing body 446A, and spacers 449 are disposed to oppose the sloping surfaces 446D. The left and right edges of the supporting plate 446B have a shape corresponding to the sloping surfaces 446D.

Furthermore, light-shielding films (not shown) are provided on the light flux emitting end surfaces of the housing body 446A and the supporting plate 446B, such that it is possible to reduce or prevent the light reflected from the cross dichroic prism 444 from being further reflected to the cross dichroic prism 444 and thus to reduce or prevent contrast from being deteriorated due to stray light.

The above-mentioned holding frame 446 is made of a synthetic resin in which a predetermined quantity of carbon as thermal conductive material is added to PPS (Polyphenylene Sulfide) and is a molded product obtained through molding such as injection molding. For example, the synthetic resin may employ Cool Poly RBO 20 (product name). Further, in addition to the above-mentioned synthetic resin, the holding frame 446 may be made of resin such as acryl material, PC (Polycarbonate), liquid crystal resin, PA (Poly Amide) and so on, or metallic material such as aluminum, magnesium, titanium, alloy including the metallic material as major material which have low weight and excellent thermal conductivity.

The pedestals 445 are fixed to the top and bottom surfaces of the cross dichroic prism 444 and fixes the optical device 44 to the light guide 47. The pedestals are made of aluminum having excellent thermal conductivity and the outer shape thereof is almost equal to the cross dichroic prism 444.

Although not shown, locating protrusions and fixing holes to couple the unified optical device 44 to the light guide 47 are formed in the lower surface of the pedestal 445 positioned at the bottom side of the cross dichroic prism 444, corresponding to the holes 482B6 formed in the bottom portion 482B of the lower light guide 48, and they are coupled with screws, etc.

The pedestals 445 are made of aluminum. However, not limited to the aluminum, the pedestals may be made of material having high thermal conductivity, such as magnesium alloy, or copper, or may be made of sapphire, quartz, fluorite, thermal conductive resin etc.

As shown in FIG. 9, the incident side transparent members 447A oppose the respective light flux incident end surfaces of the cross dichroic prism 444, and includes an R color light incident side transparent member 447A1 which the R color light enters, a G color light incident side transparent member 447A2 which the G color light enters, and a B color light incident side transparent member 447A3 which the B color light enters. The incident side transparent members 447A are formed in a plate shape with almost the same length or width and height in a state where the pedestal 445 is fixed to the cross dichroic prism 444. Further, the incident side transparent members 447A have the same thickness. One end surface of the incident side transparent members 447A hold and fix the respective light modulating devices 440 and the other end surface thereof are fixed to the side surfaces of the pedestals 445 with the elastic members 448 therebetween.

Polarizing films 443A are adhered to almost the centers of the incident side transparent members 447A. That is, the incident side transparent members 447A have a function to hold and to fix the light modulating devices 440 and a function as emitting side polarizing plates 443 due to the polarizing films 443A adhered thereto.

Here, the incident side transparent members 447A may employ various kinds of material and may employ, for example, thermal conductive material such as sapphire, crystal, quartz glass, fluorite, etc. In this exemplary embodiment, the R color light incident side transparent member 447A1 is made of crystal, and the G color light incident side transparent member 447A2 and the B color light incident side transparent member 447A3 are made of sapphire. In this exemplary embodiment, the thermal conductivity of the R color light incident side transparent member 447A1 (crystal: axis direction: 9.3 W/m·K, direction perpendicular to the axis: 5.4 W/m·K) is set to be smaller than the thermal conductivity of the G color light incident side transparent member 447A2 and the B color light incident side transparent member 447A3 (sapphire: 42 W/m·K) in accordance with difference in heat generated in the respective liquid crystal panels 441 due to the light flux emitted from the light source lamp 416. The thermal resistances of spaces between the respective members of the light flux incident end surfaces of the cross dichroic prism 444 and the three light modulating devices 440, are set to be different.

On the other hand, the heat generated in the liquid crystal panels 441 are influenced mainly by a relative radiation intensity of a light-emission spectrum from the light source lamp 416. In the light source lamp 416 employed in this exemplary embodiment, although not shown, the relative radiation intensity of the light-emission spectrum in a red wavelength band of 620 to 750 nm is smaller than the relative radiation intensity of the light-emission spectrum in a green wavelength band of 500 to 550 nm and a blue wavelength band of 400 to 500 nm. For this reason, in the liquid crystal panels 441, the heat value from the liquid crystal panel 441R is smaller than those from the liquid crystal panels 441G and 441B.

As shown in FIG. 9, the emitting side transparent member 447B oppose the light flux emitting end surface of the cross dichroic prism 444. The size of the emitting side transparent member 447B is almost equal to the size of the incident side transparent members 447A. One end surface of the emitting side transparent member 447B is fixed to the side surfaces of the pedestals 445 with the elastic members 448 therebetween.

Here, the emitting side transparent member 447B may employ various kinds of material and may employ, for example, thermal conductive material such as sapphire, crystal, quartz, fluorite, etc. In this exemplary embodiment, the emitting side transparent member 447B is made of sapphire.

The lateral edges of the three incident side transparent members 447A and the emitting side transparent member 447B are connected to each other, thereby surrounding the cross dichroic prism 444.

As shown in FIG. 9, the elastic members 448 are interposed between the incident side transparent members 447A and the side surfaces of the pedestals 445, and thus mitigate the thermal stress generated in the junctions between the incident side transparent members 447A and the pedestals 445. The elastic members 448 may be made of silicon rubber having excellent thermal conductivity and elasticity, of which one or both surfaces have been subjected to surface treatment for enhancing a cross-link density. For example, Circon GR-d series (trademark of FUJI POLYMER Co., Ltd.) may be employed. Here, since the surface has been subjected to the surface treatment, it is possible to facilitate the locating of the elastic members 448 to the pedestal 445 when assembling the optical device 44.

As shown in FIG. 9, the spacers 449 are interposed between the holding frame 446 and the incident side transparent member 447A, and locate the holding frame 446. The spacers 449 have almost a triangular section and are made of sapphire.

Two spacers 449 are disposed in the respective holding frames 446 (total six spacers), come in contact with the sloping surfaces 446D of the holding frame 446, move the holding frame 446 with movement of the spacers 449, and locate the respective liquid crystal panel 441R, 441G and 441B with respect to the back focus position from the projection lens 46.

Here, the spacers 449 are made of sapphire, but are not limited to sapphire. The spacers may be made of crystal, quartz glass, fluorite, etc.

1-4. Method of Manufacturing Optical Device

Hereinafter, a method of manufacturing the optical device will be described in detail with reference to FIGS. 8 and 9.

First, the polarizing films 443A are adhered to the incident side transparent members 447A, and the prism unit is assembled through the following processes (A), (B) and (C).

(A) The pedestals 445 are adhered and fixed to the top and bottom surfaces of the cross dichroic prism 444 with thermosetting adhesive having excellent thermal conductivity.

(B) The elastic members 448 are adhered and fixed to the side surfaces of the pedestals 445 with the thermosetting adhesive having excellent thermal conductivity.

(C) The incident side transparent members 447A to which the polarizing films 443A are adhered, and the emitting side transparent member 447B are connected to surround the light flux incident end surfaces and the light flux emitting end surface of the cross dichroic prism 444 with the elastic members therebetween and then are adhered and fixed with the thermosetting adhesive or the light-curable adhesive having excellent thermal conductivity.

Next, the holding frames 446 are assembled and are fixed to the prism unit through the following processes (D) and (E).

(D) The respective liquid crystal panels 441R, 441G and 441B are housed in the housing bodies 446A of the corresponding holding frames 446 and are positioned using the outer circumferences of the corresponding light-transmitting dustproof plates fixed to the counter substrates 441E. Further, the housing bodies 446A and the liquid crystal panels 441R, 441G and 441B are fixed to each other using a thermal conductive adhesive. Thereafter, the supporting plates 446B of the holding frames 446 are attached from the insertion side of the liquid crystal panel to the housing bodies 446A, thereby to press, fix, and hold the respective liquid crystal panels 441R, 441G and 4411B.

The attachment of the supporting plate 446B to the housing bodies 446A is performed by locking the hooks 446B 1 of the supporting plates 446B to the hook locking portions 446A1 of the housing bodies 446A.

(E) The supporting plate 446B side surfaces of the holding frames 446 having held the respective liquid crystal panels 441R, 441G and 441B are brought into contact with the incident side transparent members 447A, respectively.

Next, the locating of the liquid crystal panels 441R, 441G and 441B is carried out through the following process (F).

(F) The spacers 449 to which light-curable adhesive is applied are interposed between the sloping surfaces 446D of the holding frames 446 and the surfaces of the incident side transparent members 447A, and the holding frames 446 are positioned at the back focus position from the projection lens 46 while moving the spacers 449 along the sloping surfaces 446D. The specific locating method will be described below.

(G) Thereafter, the respective members are fixed by curing the adhesive.

The optical device is manufactured through the above-mentioned processes.

Here, the movement of the spacers 449 is carried out using the surface tension of the photocurable adhesive applied to the surfaces of the spacers 449. In a method of fixing the holding frames 446, the incident side transparent members 447A, and the spacers 449, for example, a temporary fixing may be first carried out in spots with the light-curable adhesive, and a main fixing may be then carried out by filling gaps between the holding frames 446 and the incident side transparent members 447A with the thermosetting adhesive. The above locating includes both of a focus adjustment and an alignment.

The attachment of the respective liquid crystal panels 441R, 441G and 441B to the cross dichroic prism 444 need not be carried out in the above-mentioned order, and it is sufficient that the state shown in FIG. 8 can be finally obtained. The liquid crystal panels 441R, 441G and 441B and the cross dichroic prism 444 unified in this way are positioned by inserting the locating protrusions formed on the lower surface of the pedestal 445 located at the lower side of the cross dichroic prism 444 into the side holes 482B6 (see FIG. 7) formed at the bottom portion 482B of the lower light guide 48, and are fixed by fitting screws, etc. into the central holes 482B6 (see FIG. 7) and the fixing holes of the pedestal 445.

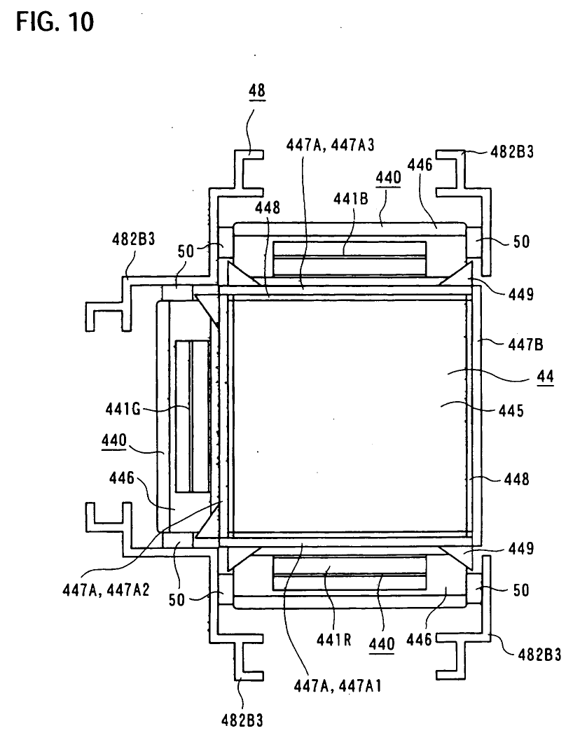

Here, in the state where the optical device 44 is fixed to the lower light guide 48, as shown in FIG. 10, the elastic members 50 are interposed between the left and right surfaces of the holding frames 446 of the optical device 44 and the third boss portion 482B3 of the lower light guide 48.

Further, the elastic members 50 are made of silicon rubber having excellent thermal conductivity, of which one or both surfaces have been subjected to surface treatment to enhance a cross-link density. For example, Circon GR-d series (trademark of FUJI POLYMER Co., Ltd.) may be employed.

1-5. Method of Locating Liquid Crystal Panel

The three-dimensional locating of the liquid crystal panels 441R, 441G and 441B about the cross dichroic prism 444 in the locating process of (G) is carried out as follows, in a state where the spacers 449, to which the light-curable adhesive is applied, are inserted between the sloping surfaces 446D of the holding frames 446 and the incident side transparent members 447A and the adhesive is not cured.

The alignment is first carried out to the liquid crystal panel 441G opposed to the projection lens 46 by using the bonding surfaces between the incident side transparent member 447A and the spacers 449 as a sliding surface, and the focus adjustment is then carried out by using the bonding surface between the holding frame 446 and the spacers 449 as a sliding surface, that is, by moving the spacers 449 along the sloping surfaces 446D of the holding frame 446. The fixing is carried out by adjusting the liquid crystal panel 441G to a predetermined position from the projection lens 46 and applying ultraviolet ray to the light-curable adhesive to cure the adhesive. Here, the ultraviolet ray is applied to the light-curable adhesive through the spacers 449 and then the light-curable adhesive is cured.

Next, the locating and the fixing of the liquid crystal panels 441R and 441B are carried out similarly to the above description with reference to the liquid crystal panel 441G first positioned and then fixed.

1-6. Cooling Structure by Cooling Unit

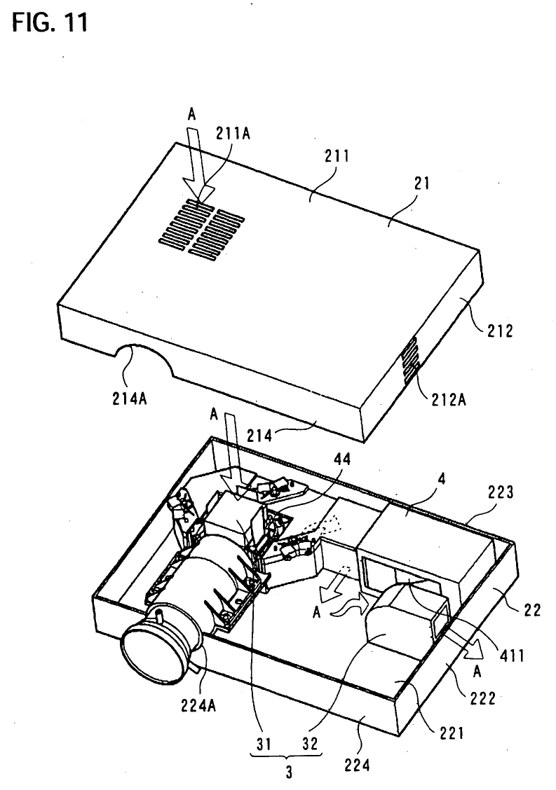

FIG. 11 is a schematic that shows a cooling flow path of the panel cooling system A.

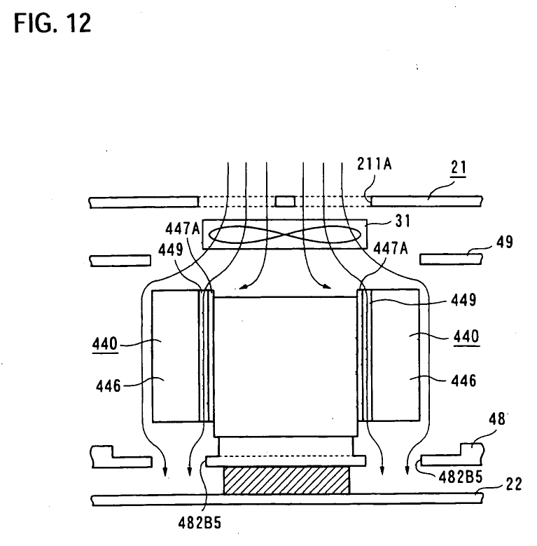

FIG. 12 is a schematic cross-sectional view showing a cooling structure for cooling the optical device 44 by the panel cooling system A.

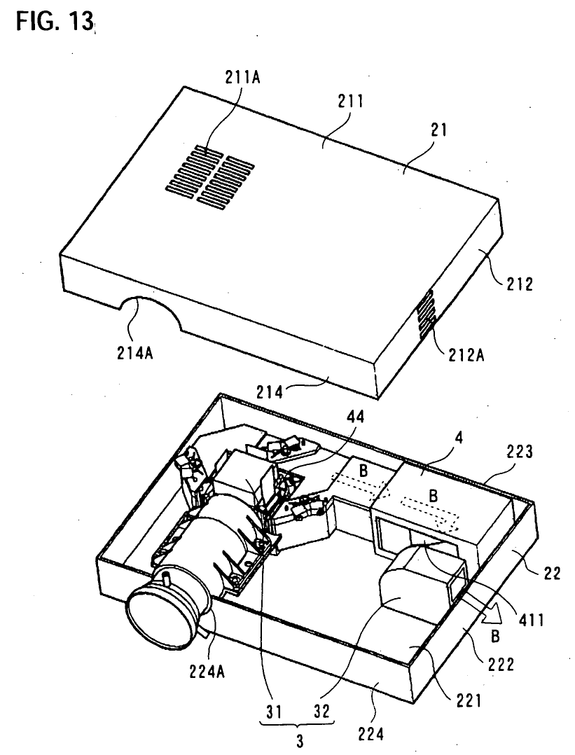

FIG. 13 is a schematic that shows the cooling flow path of the light source cooling system B.

The projector 1 according to this exemplary embodiment comprises the panel cooling system A to mainly cool the liquid crystal panels 441R, 441G and 441B and the light source cooling system B to mainly cool the light source device 411.

As shown in FIG. 11, the axial flow fan 31 disposed above the optical device 44 is used in the panel cooling system A. The cooled air sucked up from the air inlet 211A formed in the top surface portion 211 of the upper case 21 by the axial flow fan 31 is introduced upside the optical device 44. Here, since the upper light guide 49 is provided in the top surface of the lower light guide 48 to expose the top surface of the optical device 44, the cooled air sucked up by the axial flow fan 31 can be introduced into the light guide 47.

The cooled air introduced into the light guide 47, as shown in FIG. 12, cools the top surface of the pedestal 445, enters gaps between the incident side transparent members 447A and the holding frames 446 formed by the spacers 449, the light flux incident sides of the holding frames 446, and the light flux emitting side of the emitting side transparent member 447B to cool the light flux emitting sides and the light flux incident sides of the liquid crystal panels 441R, 441G and 441B, the holding frames 446, the incident side transparent members 447A, the emitting side transparent member 447B, and the polarizing films 443A, and then is externally discharged from the light guide 47 through the air outlet 482B5 (see FIG. 7) formed in the bottom portion 482B of the lower light guide 48.

The air discharged from the light guide 47 is guided into the ducts 482B7 formed in the state where the lower light guide 48 is in contact with the bottom surface portion 221 of the lower case 22, and is sent toward the front of the optical unit 4. Then, the air is sucked up by the sirocco fan 32 disposed in the vicinity of the light source device 411 and is discharged through the air outlet 212A formed in the side surface portion 212 of the upper case 21.

As shown in FIG. 13, the sirocco fan 32 disposed in the vicinity of the light source device 411 is used in the light source cooling system B.

The air inlet of the sirocco fan 32 is disposed to oppose the opening 481A formed in the side surface of the light source housing section 481 of the lower light guide 48 and the rectangular gap formed by the erected pieces of the fixing plate 411B for loading and fixing the light source device 411.

A part of the cooled air introduced into the light guide 47 by the panel cooling system A, as shown in FIG. 13, passes through the inside of the light guide 47 and is introduced into the rear side of the light source device 411 by means of the sirocco fan 32.

In the course of introducing the cooled air by the sirocco fan 32, the cooled air passes through and cools the first lens array 412, the second lens array 413, and the polarization converting element 414, which are unified, and then cools the light source lamp 416 and the elliptical mirror 417 provided in the light source device 411. The air having cooled the light source device 411, etc. is sucked up by the sirocco fan 32 and is discharged through the air outlet 212A formed in the side surface portion 212 of the upper case 21.

1-7. Advantages of First Exemplary Embodiment

According to the first exemplary embodiment, the following advantages can be accomplished.

(1) The optical device 44 includes the incident side transparent members 447A made of thermal conductive material, and the incident side transparent members 447A are interposed between the respective members of the light flux incident end surfaces of the cross dichroic prism 444 and the three light modulating devices 440, respectively, thereby holding and fixing the respective light modulating devices 440. As a result, the heat generated in the light modulating devices 440 can be radiated through the incident side transparent members 447A made of thermal conductive material. Therefore, the respective light modulating devices 440 can be cooled with a simple configuration, without increasing the blowing air quantity of the axial flow fan 31 in the cooling unit 3.

(2) The R color light incident side transparent member 447A1 is made of quartz, and the G color light incident side transparent member 447A2 and the B color light incident side transparent member 447A3 are made of sapphire, such that the thermal resistance of a space between the respective members of the light modulating device 440 having the liquid crystal panel 441G or 441B and the light flux incident end surface of the cross dichroic prism 444 is smaller than the thermal resistance between the light modulating device 440 having the liquid crystal panel 441R and the light flux incident end surface of the cross dichroic prism 444. As a result, the heat of the liquid crystal panel 441G and 441B having a relatively large heat value can be efficiently cooled through the incident side transparent members 447A2 and 447A3, and unevenness in temperature of the light modulating devices 440 can be equalized with a simple configuration. Therefore, it is possible to equalize the thermal expansion quantities of the respective holding frames 446 to house and to hold the liquid crystal panels 441, such that the image quality of the optical image formed by the optical device 44 can be maintained excellent.

(3) Since the pedestals 445 made of aluminum are fixed to the top and bottom surfaces of the cross dichroic prism 444 and the incident side transparent members 447A are connected to the side surfaces of the pedestals 445, the heat generated in the respective light modulating devices 440 can be radiated through the respective incident side transparent members 447A and can be further radiated through the pedestals 445. Therefore, it is possible to further enhance or improve the cooling efficiency of the respective light modulating devices 440.

(4) The optical device 44 includes the emitting side transparent member 447B, and the emitting side transparent member 447B is disposed to oppose the light flux emitting end surface of the cross dichroic prism 444 is connected to the side surface of the pedestals 445 and connected to the R color light incident side transparent member 447A1 and the B color light incident side transparent member 447A3. As a result, the emitting side transparent member 447B as well as the incident side transparent members 447A can serve as a radiation path of the heat generated in the light modulating devices 440, such that it is possible to further enhance the cooling efficiency of the respective light modulating devices 440.

(5) Since the incident side transparent members 447A and the emitting side transparent member 447B are connected to surround the light flux incident end surfaces and the light flux emitting end surface of the cross dichroic prism 444, unevenness in temperature due to unevenness in heating quantity generated in the respective liquid crystal panels 441 can be rapidly equalized.

(6) The elastic members 448 having excellent thermal conductivity are interposed between the side surfaces of the pedestals 445 and the incident side transparent members 447A and emitting side transparent member 447B. As a result, when the incident side transparent members 447A, the emitting side transparent member 447B, and the pedestals 445 are thermally expanded due to the heat generated in the respective light modulating devices 440, the thermal stress generated between the members can be absorbed by the elastic members 448. Therefore, since the connection condition of the incident side transparent members 447A and the emitting side transparent member 447B to the pedestals 445 can be maintained, it is possible to reduce or prevent the pixel deviation or the focus deviation.

(7) Since the elastic members 448 have excellent thermal conductivity, the connection condition of the incident side transparent members 447A and the emitting side transparent member 447B to the pedestals 445 can be maintained, and the heating property from the incident side transparent members 447A and the emitting side transparent member 447B to the pedestals 445 can be enhanced or improved, such that it is possible to enhance the cooling efficiency of the respective light modulating devices 440.

(8) The elastic members 448 are thermally expanded due to the heat generated in the respective light modulating devices 440, and the close adherent property between the incident side transparent members 447A and emitting side transparent member 447B and the pedestals 445 is enhanced or improved due to the thermal expansion of the elastic member 448, such that it is possible to enhance the thermal conductivity from the incident side transparent members 447A and the emitting side transparent member 447B to the pedestals 445.

(9) Since the third boss portion 482B3 is formed in the lower light guide 48 and the elastic members 50 are interposed between the holding frames 446 and the third boss portion 482B3, the radiation paths of the heat generated in the respective light modulating devices 440 are provided in parallel and thus the whole heating quantity is increased, such that it is possible to enhance the cooling efficiency of the respective light modulating devices 440. In addition, by reducing the heating quantity to the polarizing films 443A, it is possible to enhance the cooling efficiency of the polarizing film 443A.

(10) Since the optical device 44 includes the spacers 449, the locating of the respective liquid crystal panels 441R, 441G and 441B can be carried out by moving the positions of the spacers 449 so as to adjust the pixel position of the image to be projected or the back focus position from the projection lens, such that it is possible to properly position the respective liquid crystal panels 441R, 441G and 441B.

(11) The spacers 449 are made of sapphire transmitting ultraviolet ray. Therefore, by using the spacers 449, to which the light-curable adhesive is applied, for bonding the incident side transparent members 447A and the respective light modulating devices 440 when manufacturing the optical device 44, the light transmits the spacers 449, such that the bonding between the holding frames 446 and the incident side transparent members 447A can be easily carried out and the productivity of the optical device 44 can be enhanced.

(12) Since the polarizing films 443A are attached to the centers of the incident side transparent members 447A, unevenness in temperature generated in the three polarizing films 443A corresponding to the respective color light components of R, G and B can be equalized. Further, since the incident side transparent members 447A also functions as the emitting side polarizing plates 443, other substrates to which the polarizing films 443A is attached can be omitted, such that it is possible to reduce a manufacturing cost.

(13) The air outlet 482B5 is formed in the bottom portion 482B of the optical component housing section 482 of the lower light guide 48 correspondingly to the positions of the respective liquid crystal panels 441 of the optical device 44 and the light flux emitting end surface of the cross dichroic prism 444. As a result, the cooled air sucked up by the axial flow fan 31 of the cooling unit 3 can be intensively emitted to the incident side transparent members 447A and the emitting side transparent member 447B through the air outlet 482B5, and the cooling of the heat generated in the respective light modulating devices 440 can be carried out by the involuntary cooling by the axial flow fan 31 and the conductive radiation in the incident side transparent members 447A and the emitting side transparent member 447B, such that it is possible to further enhance the cooling efficiency of the respective light modulating devices 440.

(14) Since the projector 1 includes the above-mentioned optical device 44, the projector can cope with decrease in size, has high silence and high cooling efficiency, and can project images having excellent image quality.

2. Second Exemplary Embodiment

Next, a second exemplary embodiment of the present invention will be described.

In the following description, the same structures and elements as the first exemplary embodiment are denoted by the same reference numerals and descriptions thereof will be omitted or simplified.

In the first exemplary embodiment, in order to make the thermal resistances in the spaces between the respective members of the light flux incident end surfaces of the cross dichroic prism 444 and the three light modulating devices 440 different in accordance with a difference in heating quantity of the light modulating devices 440, the thermal conductivity of the R color light incident side transparent member 447A1 of the three incident side transparent members 447A disposed at the spaces between the respective members is different from the thermal conductivity of the G color light incident side transparent member 447A2 and the B color light incident side transparent member 447A3.

On the contrary, in the second exemplary embodiment, in order to make the thermal resistances in the space between the respective members of the light flux incident end surfaces of the cross dichroic prism 444 and the three light modulating devices 440 different in accordance with a difference in heating quantity of the light modulating devices 440, the thicknesses of at least two incident side transparent members 447A of the three incident side transparent members 447A disposed at the spaces between the respective members are set to be different from each other.

The other configuration is similar to the first exemplary embodiment and descriptions thereof will be omitted.

2-1. Structure of Optical Device

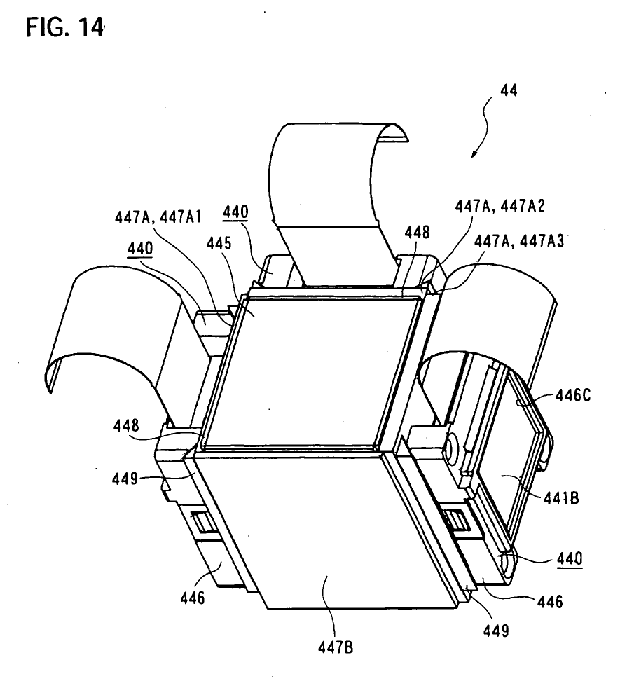

Specifically, FIG. 14 is a perspective view showing the optical device 44 according to the second exemplary embodiment as seen from the top.

The incident side transparent members 447A include the R color light incident side transparent member 447A1, the G color light incident side transparent member 447A2, and the B color light incident side transparent member 447A3, similarly to the first exemplary embodiment.

The thickness of the G color light incident side transparent member 447A2 and the B color light incident side transparent member 447A3 of the incident side transparent members 447A is set to be larger than the thickness of the R color light incident side transparent member 447A1.

Here, the thermal resistance of a member is generally inversely proportional to the thermal conductivity of the member and inversely proportional to a sectional area of the member. That is, in this exemplary embodiment, the thermal resistance of the R color light incident side transparent member 447A1 is set to be larger than the thermal resistance of the G color light incident side transparent member 447A2 and the B color light incident side transparent member 447A3.

Further, the incident side transparent members 447A may employ various kinds of material and may employ, for example, thermal conductive material such as sapphire, crystal, quartz glass, fluorite, etc. In this exemplary embodiment, the three incident side transparent members 447A are all made of sapphire.

Since the method of manufacturing the optical device 44 and the method of locating the liquid crystal panels 441 are similar to the first exemplary embodiment, descriptions thereof will be omitted.

2-2. Advantages of Second Exemplary Embodiment

According to the second exemplary embodiment, the following advantages can be accomplished, in addition to at least the above-mentioned advantages (1) and (3) to (14).

(15) The thickness of the R color light incident side transparent member 447A1 is set to be smaller than the thickness of the G color light incident side transparent member 447A2 and the B color light incident side transparent member 447A3, and the thermal resistance in the space between the respective members of the light modulating device 440 including the liquid crystal panel 441G or 441B and the light flux incident end surfaces of the cross dichroic prism 444 is set to be smaller than the thermal resistance in the space between the respective members of the light modulating device 440 comprising the liquid crystal panel 441R and the light flux incident end surface of the cross dichroic prism 444. Thereby, the heat of the liquid crystal panels 441G and 441B having a relatively large heating quantity can be efficiently cooled through the incident side transparent members 447A2 and 447A3 having a smaller thermal resistance, such that it is possible to equalize unevenness in temperature of the respective light modulating devices 440 with a simple configuration. Therefore, it is possible to keep the image quality of the optical image formed by the optical device 44 excellent.

3. Third Exemplary Embodiment

Next, a third exemplary embodiment of the present invention will be described.

In the following description, the same structures and elements as the first and second exemplary embodiments are denoted by the same reference numerals and descriptions thereof will be omitted or simplified.

In the first exemplary embodiment and the second exemplary embodiment, the incident side transparent members 447A are disposed at all spaces between the respective members of the light flux incident end surfaces of the cross dichroic prism 444 and the three light modulating devices 440.

On the contrary, in the third exemplary embodiment, the incident side transparent members 447A are disposed at the spaces between the respective members of the light flux incident end surfaces of the cross dichroic prism 444 and the three light modulating devices 440 excluding at least one space.

3-1. Structure of Optical Device

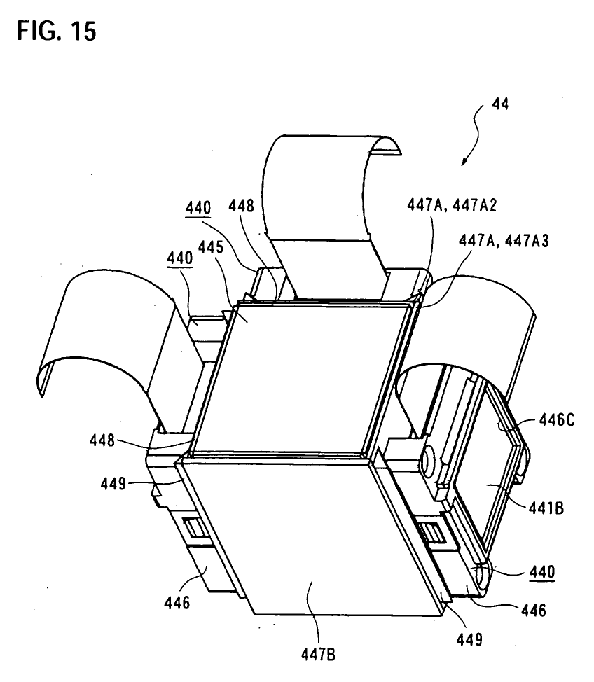

Specifically, FIG. 15 is a schematic perspective view showing the optical device 44 according to the third exemplary embodiment as seen from the top.

The incident side transparent members 447A include the G color light incident side transparent member 447A2 and the B color light incident side transparent member 447A3. That is, the R color light incident side transparent member 447A1 is omitted from the incident side transparent members 447A in the first exemplary embodiment and the second exemplary embodiment. In this configuration, since the incident side transparent members 447A include the G color light incident side transparent member 447A2 and the B color light incident side transparent member 447A3, the spaces between the respective members of the cross dichroic prism 444 and the light modulating devices 440 at which the incident side transparent members are disposed and the space at which the incident side transparent member 447A is not disposed are different in thermal resistance. That is, the spaces between the respective members at which the incident side transparent members 447A are disposed have the smaller thermal resistance than the space at which the incident side transparent member 447A is not disposed.

Further, the G color light incident side transparent member 447A2 and the B color light incident side transparent member 447A3 have almost the same outer shape and are made of the same material. In this exemplary embodiment, the G color light incident side transparent member 447A2 and the B color light incident side transparent member 447A3 are made of sapphire.

Furthermore, with omission of the R color light incident side transparent member 447A1, the polarizing film 443A of the liquid crystal panel 441R is attached to the light flux incident end surface of the cross dichroic prism 444.

Since the method of manufacturing the optical device 44 and the method of locating the liquid crystal panels 441 are similar to the first exemplary embodiment and the second exemplary embodiment, descriptions thereof will be omitted.

3-2. Advantages of Third Exemplary Embodiment

According to the third exemplary embodiment, the following advantages can be accomplished, in addition to at least the above-mentioned advantages (3) to (14).

(16) The optical device 44 includes the incident side transparent members 447A including the G color light incident side transparent member 447A2 and the B color light incident side transparent member 447A3, which are made of sapphire. Further, the incident side transparent members 447A are disposed at the spaces between the respective members of the light modulating devices 440 including the liquid crystal panel 441G and the light modulating device 440 including the liquid crystal panel 441B and the light flux incident end surfaces of the cross dichroic prism 444, and hold and fix the respective light modulating devices 440. Thereby, the heat generated in the light modulating device 440 including the liquid crystal panel 441G or the liquid crystal panel 441B can be radiated through the incident side transparent member 447A made of sapphire. Therefore, it is possible to efficiently cool the light modulating devices 440 having a relatively large heating quantity with a simple configuration, without increasing the blowing air quantity of the axial flow fan 31 in the cooling unit 3.

(17) Since the incident side transparent member 447A is not disposed at the space between the respective members of the light modulating device 440 including the liquid crystal panel 441R having a relatively small heating quantity and the cross dichroic prism 444, the thermal resistance in the space between the respective members of the light modulating device 440 including the liquid crystal panel 441G or the liquid crystal panel 441B and the light flux incident end surface of the cross dichroic prism 444 is set to be smaller than the thermal resistance in the space between the respective members of the light modulating device 440 including the liquid crystal panel 441R and the light flux incident end surface of the cross dichroic prism 444. Thereby, unevenness in temperature of the respective light modulating devices 440 can be equalized with a simple configuration. Therefore, it is possible to equalize the thermal expansion quantity of the respective holding frames 446 to house and to hold the respective liquid crystal panels 441, such that it is possible to maintain the image quality of the optical image formed by the optical device 44 excellent.

4. Modification of the Exemplary Embodiments

Although various exemplary embodiments of the present invention have been described above, the present invention is not limited to the above exemplary embodiments, but may include other configurations. For example, modifications shown in the following description can be included in the present invention.

Although it is described in the first exemplary embodiment that the R color light incident side transparent member 447A1 has a thermal conductivity smaller than those of the G color light incident side transparent member 447A2 and the B color light incident side transparent member 447A3, the present invention is not limited to the exemplary embodiment, but at least two incident side transparent members of the three incident side transparent members 447A may have different thermal conductivities.

All of the three incident side transparent members 447A may have different thermal conductivities. For example, in the liquid crystal panels 441R, 441G and 441B, when the heating quantity of the liquid crystal panel 441R is larger than the heating quantity of the liquid crystal panel 441G which is in turn larger than the heating quantity of the liquid crystal panel 441B, the thermal conductivities of the respective incident side transparent members 447A may be set to the thermal conductivity of the R color light incident side transparent member 447A1 larger than the thermal conductivity of the G color light incident side transparent member 447A2 which is in turn larger than the thermal conductivity of the B color light incident side transparent member 447A3. That is, the incident side transparent members 447A may be designed in accordance with differences in heating quantity of the liquid crystal panels 441.

In the above respective exemplary embodiments, the emitting side transparent member 447B is made of sapphire, but is not limited to sapphire and may be made of thermal conductive material such as crystal, quartz glass, fluorite, etc.

Further, the emitting side transparent member 447B may have a thermal conductivity larger than those of the incident side transparent members 447A, or may have a sectional area larger than those of the incident side transparent members 447A along the top and bottom surfaces of the cross dichroic prism 444. In such a configuration, the emitting side transparent member 447B has a thermal resistance smaller than those of the incident side transparent members 447A and the heat transmission from the incident side transparent members 447A to the emitting side transparent member 447B are efficiently carried out, such that it is possible to rapidly equalize unevenness in heating quantity of the respective light modulating devices 440.

Although it has been described in the second exemplary embodiment that the R color light incident side transparent member 447A1 has a thickness smaller than those of the G color light incident side transparent member 447A2 and the B color light incident side transparent member 447A3, the present invention is not limited to this exemplary embodiment, but at least two incident side transparent members of the three incident side transparent members 447A may have different thicknesses.

For example, in the three liquid crystal panels 441R, 441G and 441B, when the heating quantity of the liquid crystal panel 441G is larger than the heating quantity of the liquid crystal panel 441R or the heating quantity of the liquid crystal panel 441B, only the thickness of the G color light incident side transparent member 447A2 may be set to be larger than that of the R color light incident side transparent member 447A1 and the B color light incident side transparent member 447A3. That is, the thicknesses of the incident side transparent members 447A may be designed correspondingly to differences in heating quantity of the liquid crystal panels 441. Further, the three incident side transparent members 447A may all have different thicknesses. Furthermore, as well as a configuration in which the thicknesses are all different, a configuration in which thicknesses and widths perpendicular thereto are different may be employed.

Further, although it has been described in the second exemplary embodiment that the two incident side transparent members 447A are made of sapphire, the present invention is not limited to this exemplary embodiment, but for example, all the three incident side transparent members 447A may be made of thermal conductive materials having different thermal conductivities. Furthermore, only one incident side transparent member 447A of the three incident side transparent members 447A may be made of thermal conductive material having a thermal conductivity different from that of the other two incident side transparent members 447A.

That is, in the second exemplary embodiment, the incident side transparent members 447A may be designed correspondingly to differences in heating quantity of the liquid crystal panels 441, similarly to the first exemplary embodiment.

Although it has been described in the third exemplary embodiment that the incident side transparent members 447A include the G color light incident side transparent member 447A2 and the B color light incident side transparent member 447A3, the present invention is not limited to this exemplary embodiment, and the incident side transparent members 447A may be disposed at the spaces between the respective members of the light flux incident end surfaces of the cross dichroic prism 444 and the three light modulating devices 440 excluding at least one space.

For example, the incident side transparent members 447A may include only the R color light incident side transparent member 447A1, or only the G color light incident side transparent member 447A2, or only the B color light incident side transparent member 447A3. Further, the incident side transparent members 447A may include any two of the R color light incident side transparent member 447A1, the G color light incident side transparent member 447A2, and the B color light incident side transparent member 447A3. That is, the liquid crystal panels employing the incident side transparent members may be selected correspondingly to the differences in heating quantity of the liquid crystal panels 441.

Furthermore, although it has been described in the third exemplary embodiment that the two incident side transparent members 447A are all made of sapphire, the present invention is not limited to this exemplary embodiment, but the two incident side transparent members 447A may be made of thermal conductive materials having different thermal conductivities.

Furthermore, although the two incident side transparent members 447A have been formed in the same outer shape in the third exemplary embodiment, the present invention is not limited to this exemplary embodiment, but the sectional areas of the two incident side transparent members 447A along the top and bottom surfaces of the cross dichroic prism 444 may be different.

That is, in the third exemplary embodiment, the incident side transparent members 447A may be designed to correspond to a difference in heating quantity of the liquid crystal panels 441, like the first exemplary embodiment and the exemplary second embodiment.

In the above respective exemplary embodiments, the pedestal 445 is fixed to both the top and bottom surfaces of the cross dichroic prism 444, but the present invention is not limited to this configuration. The pedestal may be fixed to at least one surface of the top and bottom surfaces.

Although it has been described in the above respective exemplary embodiments that the cooling unit 3 has the axial flow fan 31, the axial flow fan 31 is provided above the optical device 44, and the cooled air flows from the top side to the bottom side, the present invention is not limited to this. For example, a configuration in which the axial flow fan 31 is provided below the optical device 44 and the cooled air flows from the bottom side of the optical device 44 to the top side thereof may be employed.

Here, it is preferable that thermal conductive member made of a flexible spring silicon rubber or the like be interposed between the pedestal 445 fixed to the top surface of the cross dichroic prism 444 and the upper light guide 49 or the upper case 21.

In such a configuration, the heat generated in the liquid crystal panels 441R, 441G and 441B due to an illumination of the light flux from the light source device 411 is radiated from the incident side transparent members 447A and the emitting side transparent member 447B to the pedestals 445. The heat delivered to the pedestals 445 is radiated to the upper light guide 49 or the upper case 21 through the spring silicon rubber. Thereby, the total conductible heating quantity radiated from the liquid crystal panels 441R, 441G and 441B or the emitting side polarizing plate 443 can be increased, such that it is possible to enhance the cooling efficiency of the respective liquid crystal panels 441 or the emitting side polarizing plate 443.

In the above respective exemplary embodiments, the spacers 449 are made of sapphire, but not limited to sapphire, the spacers may be formed out of a metallic member.

In such a configuration, the thermal resistance between the holding frames 446 to house and to hold the liquid crystal panels 441 and the incident side transparent members 447A can be reduced. Therefore, the heat generated in the liquid crystal panels 441 or the emitting side polarizing plates 443 due to an illumination of the light flux from the light source device 411 can be efficiently radiated, such that it is possible to further enhance the cooling efficiency of the liquid crystal panels 441 or the emitting side polarizing plates 443.

In the above respective exemplary embodiments, although the spacers 449 are formed into left and right members and are provided on the sloping surface 446D formed at the left and right side edges of the holding frames 446, the present invention is not limited to this. For example, each spacer may be formed out of a plurality of spacers provided at the respective left and right side edges of the holding frames 446 with a length smaller than a side length of the holding frames 446.

In such a configuration, the thermal stress between the holding frames 446 and the incident side transparent members 447A is dispersed by the plurality of spacers, such that the deformation of the outer shape of the spacers can be reduced and the holding frames 446 can be surely held. Therefore, it is possible to secure mutual positional conditions of the liquid crystal panels 441 and to reduce or prevent the pixel deviation of the image to be projected.

Although the projector 1 employing the three light modulating devices 440 has been exemplified in the above exemplary embodiments, the present invention may be applied to a projector employing only one light modulating device, or a projector employing two light modulating devices, or a projector employing four or more light modulating devices.

Although the optical unit 4 having an L shape in a plan view has been used in the above exemplary embodiments, the present invention is not limited to this, but for example, an optical unit having a U shape as seen two-dimensionally may be used.

Although it has been described in the above-mentioned respective exemplary embodiments that the liquid crystal panels 441 are used as the light modulating elements, light modulating elements such as devices using a micromirror other than liquid crystal may be employed.

Although the transmissive liquid crystal panels 441 in which the light flux incident surface and the light flux emitting surface are different from each other has been employed in the above-mentioned respective exemplary embodiments, a reflective light modulating elements in which the light flux incident surface and the light flux emitting surface are the same may be employed.

Although a front type projector for performing the projection from a direction facing a screen has been exemplified in the above exemplary embodiments, the present invention can be applied to a rear type projector for performing the projection from an opposite side to a direction facing the screen.

1. An optical device, comprising:
a plurality of light modulating devices to modulate a plurality of color light components in accordance with image information for every color light component;
a color synthesizing optical device having a plurality of light flux incident end surfaces opposing the respective light modulating devices to synthesize and to emit the color light components modulated by the respective light modulating devices; and
a plurality of incident side transparent members made of a thermal conductive material, which are interposed between respective members of the light flux incident end surfaces and the light modulating devices and are connected to the light modulating devices, at least two incident side transparent members of the plurality of incident side transparent members being different in thermal resistance.

2. An optical device, comprising:
a plurality of light modulating devices to modulate a plurality of color light components in accordance with image information for every color light component;
a color synthesizing optical device having a plurality of light flux incident end surfaces opposing the respective light modulating devices to synthesize and to emit the color light components modulated by the respective light modulating devices; and
a plurality of incident side transparent members made of a thermal conductive material, which are interposed between respective members of the light flux incident end surfaces and the light modulating devices excluding at least one space and are connected to the light modulating devices.

3. The optical device according to claim 1, at least two incident side transparent members of the plurality of incident side transparent members being made of thermal conductive materials having different thermal conductivities.

4. The optical device according to claim 1, at least two incident side transparent members of the plurality of incident side transparent members having different sectional areas in a direction along an end surface crossing the plurality of light flux incident end surfaces of the color synthesizing optical device.

5. The optical device according to claim 1, further comprising a pedestal provided in at least one end surface of end surfaces crossing the light flux incident end surfaces of the color synthesizing optical device and made of a thermal conductive material,
the incident side transparent members being connected to side surfaces of the pedestal.

6. The optical device according to claim 1, further comprising an emitting side transparent member made of a thermal conductive material, which oppose a light flux emitting end surface of the color synthesizing optical device.

7. The optical device according to claim 6, the emitting side transparent member having a thermal resistance smaller than those of the incident side transparent members.

8. The optical device according to claim 7, the emitting side transparent member being made of thermal conductive material having a thermal conductivity larger than those of the incident side transparent members.

9. The optical device according to claim 7, a sectional area of the emitting side transparent member, in a direction along an end surface crossing the plurality of light flux incident end surfaces of the color synthesizing optical device, being larger than those of the incident side transparent members.

10. A projector to modulate a light flux emitted from a light source in accordance with image information to form an optical image, and to enlarge and to project the optical image, comprising: the optical device according to claim 1.

11. The projector according to claim 10, the optical device including an emitting side transparent member made of a thermal conductive material, which oppose a light flux emitting end surface of the color synthesizing optical device, and
an optical component case body to house the optical device including ventilating openings for passing cooled air, the ventilating opening are formed at positions in accordance with the respective light flux incident end surfaces and the light flux emitting end surface of the color synthesizing optical device.

12-15. (Canceled)

16. The projector according to claim 10, at least two incident side transparent members of the plurality of incident side transparent members being made of thermal conductive materials having different thermal conductivities.

17. The projector according to claim 10, at least two incident side transparent members of the plurality of incident side transparent members having different sectional areas in a direction along an end surface crossing the plurality of light flux incident end surfaces of the color synthesizing optical device.

18. The projector according to claim 10, further comprising a pedestal provided in at least one end surface of end surfaces crossing the light flux incident end surfaces of the color synthesizing optical device and made of a thermal conductive material, the incident side transparent members being connected to side surfaces of the pedestal.

19. The projector according to claim 10, further comprising an emitting side transparent member made of a thermal conductive material, which oppose a light flux emitting end surface of the color synthesizing optical device.

20. The projector according to claim 19, the emitting side transparent member having a thermal resistance smaller than those of the incident side transparent members.

21. The projector according to claim 20, the emitting side transparent member being made of thermal conductive material having a thermal conductivity larger than those of the incident side transparent members.

22. The projector according to claim 20, a sectional area of the emitting side transparent member, in a direction along an end surface crossing the plurality of light flux incident end surfaces of the color synthesizing optical device, being larger than those of the incident side transparent members.

23. The optical device according to claim 2, at least two incident side transparent members of the plurality of incident side transparent members being made of thermal conductive materials having different thermal conductivities.

24. A projector to modulate a light flux emitted from a light source in accordance with image information to form an optical image, and to enlarge and to project the optical image, comprising:
the optical device according to claim 1;
a plurality of light modulating devices to modulate a plurality of color light components in accordance with image information for every color light component;
a color synthesizing optical device having a plurality of light flux incident end surfaces opposing the respective light modulating devices to synthesize and to emit the color light components modulated by the respective light modulating devices; and
a plurality of incident side transparent members made of a thermal conductive material, which are interposed between respective members of the light flux incident end surfaces and the light modulating devices excluding at least one space and are connected to the light modulating devices.

25. The projector according to claim 24, at least two incident side transparent members of the plurality of incident side transparent members being made of thermal conductive materials having different thermal conductivities.
